(19) United States
(12) Patent Application Publication
(10) Pub. No.: US 2015/0086702 A1
(43) Pub. Date: Mar. 26, 2015

(54) POPCORN MACHINE

(71) Applicant: 8479950 CANADA INC., Montreal (CA)

(72) Inventors: Martin GAGNON, Blainville (CA); Jamie COBLENTZ, Montreal (CA); Wilson HUM, Montreal (CA)

(21) Appl. No.: 14/495,049

(22) Filed: Sep. 24, 2014

Related U.S. Application Data
(60) Provisional application No. 61/881,698, filed on Sep. 24, 2013.

(51) Int. Cl. A23L 1/18

(52) U.S. Cl. CPC A23L 1/1812; A23V 2002/00
USPC 426/625; 99/323.9

(57) ABSTRACT

A machine for popping corn out of corn kernel and for delivering the popcorn to a container, the machine includes a body having a popcorn popper; and a popcorn receptacle disposed adjacent to the popcorn popper. When the popcorn popper is in operation, popcorn expelled by the popcorn popper falls into the popcorn receptacle. The popcorn receptacle has at least one inclined wall. A valve is disposed in the popcorn receptacle at a bottom end of the at least one inclined wall. The valve selectively releases the popcorn from the popcorn receptacle to the container. A method of making and delivering popcorn in a popcorn machine to a container is also presented.

### BACKGROUND

Commercial or large format popcorn makers that are commonly found in movie theaters and carnivals, for example, pop the corn kernels in a kettle with a stirring rod using oil and heat, and distribute the popped corn in bulk in an open receptacle. The user would then scoop a serving of popcorn and manually transfer that portion into a portable vessel for consumption. It can be unhygienic to manipulate the food from these type of food making appliances and it is less healthy to use oil in the preparation of popcorn.

### BRIEF SUMMARY

In one aspect, there is provided a machine for popping corn out of corn kernel and for delivering the popcorn to a container, the machine comprising: a body including: a popcorn popper; and a popcorn receptacle disposed adjacent to the popcorn popper, when the popcorn popper is in operation, popcorn expelled by the popcorn popper falling into the popcorn receptacle, the popcorn receptacle having at least one inclined wall; and a valve disposed in the popcorn receptacle at a bottom end of the at least one inclined wall, the valve selectively releasing the popcorn from the popcorn receptacle to the container.

In another aspect, there is provided a method of making and delivering popcorn in a popcorn machine to a container, the method comprising: popping corn kernel in a popcorn popper thereby forcing the popcorn to be ejected upwardly as it is popped; collecting the ejected popcorn as it falls downwardly due to gravity in a popcorn receptacle disposed adjacent to the popcorn popper; and selectively releasing the popcorn using a valve disposed at a bottom of the popcorn receptacle into the container

### BRIEF DESCRIPTION OF THE DRAWINGS

For a better understanding of the present, as well as other aspects, and further features thereof, reference is made to the following description which is to be used in conjunction with the accompanying drawings, where:

FIG. 1 is a perspective view of a food distribution machine in the shape of a candy machine, shown as a free standing machine;

FIG. 2 is a perspective view of the food distribution machine of FIG. 1, shown as a tabletop appliance;

FIG. 3 is a perspective close up view of a top of the food distribution machine of FIG. 1 shown with a top open;

FIG. 4 is a perspective view of a candy distributor of the food distribution machine of FIG. 1;

FIG. 5 a perspective view of a popcorn maker and distribution machine according to a first embodiment, shown as a free standing machine;

FIG. 6 is a perspective view of the food distribution machine of FIG. 5, shown as a tabletop appliance;

FIG. 7 is a perspective view of a top portion of the food distribution machine of FIG. 5 with some elements removed for clarity;

FIG. 8 is another perspective view of a top portion of the food distribution machine of FIG, 5 with some elements removed for clarity;

FIG. 9 is a top perspective view of a top portion of the food distribution machine of FIG. 5 with some elements removed for clarity;

FIG. 10 is a front elevation view of a top portion of the food distribution machine of FIG. 5 showing a hot air popper;

FIG. 11 a perspective view of a popcorn maker and distribution machine according to a second embodiment, shown as a free standing machine and with doors open;

FIG. 12 a perspective view of the popcorn maker and distribution machine of FIG. 11 shown with doors closed;

FIG. 13 is a flow chart representing a method of making and delivering popcorn in one of the popcorn machines of FIGS. 5 and 11;

FIG. 14 a perspective view of a food maker and distribution machine in the shape of a snow cone machine, shown as a free standing machine:

FIG. 15 is a perspective view of the food distribution machine of FIG. 14, shown as a tabletop appliance; and

FIG. 16 a perspective view of a food maker and distribution machine in the shape of a cotton candy machine, shown as a free standing machine.

### DETAILED DESCRIPTION

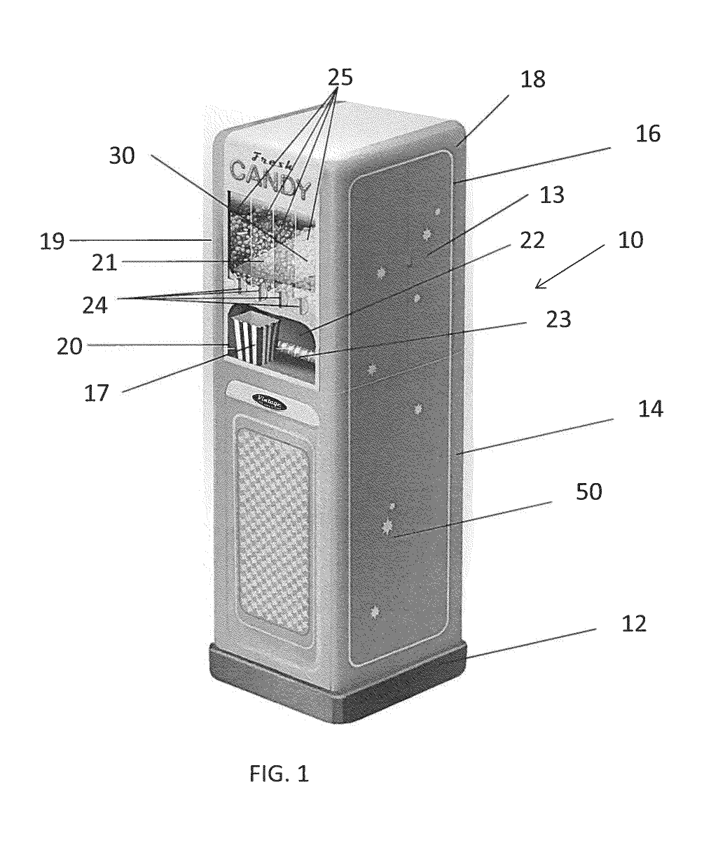

Referring to FIGS. 1 to 4, a candy distribution machine 10 will be described.

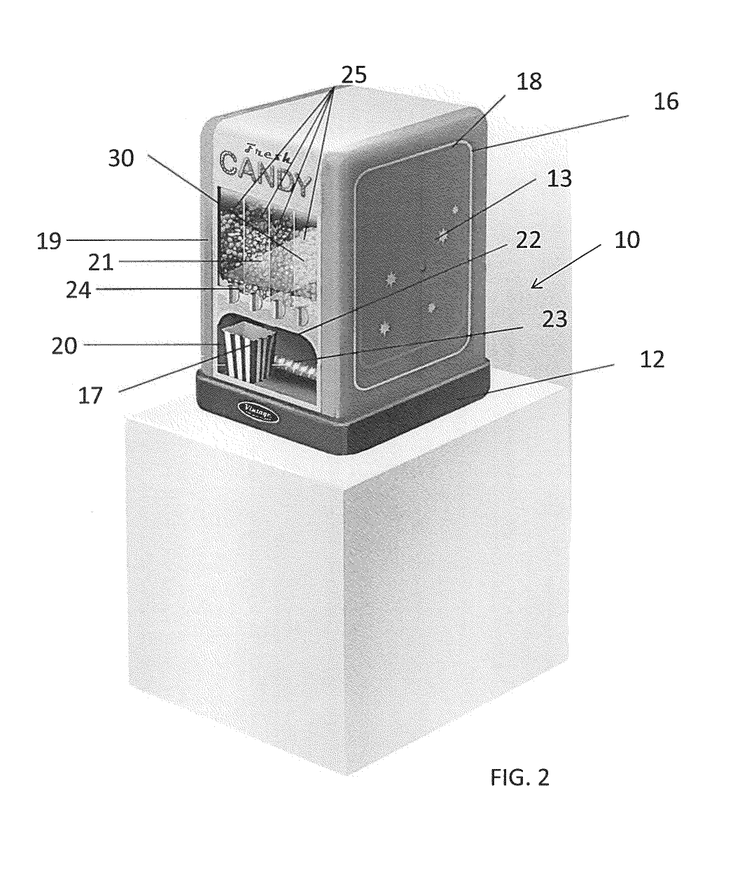

The candy machine 10 is a unit convertible between a free standing machine shown in FIG. 1 and a tabletop appliance shown in FIG. 2. To this end the candy machine 10 is connectable to a tabletop base 12 to become a tabletop appliance and to a pedestal 14 to become a free standing machine. The tabletop base 12 and the pedestal 14 will be described below. It is contemplated however, that the candy machine 10 could be only a tabletop appliance or only a free standing machine without possibility of conversion between these two.

The candy machine 10 includes a generally paralielipedic body 16. A bottom (not shown) of the body 16 is connectable to the tabletop base 12 and to the pedestal 14. The body 16 is made of plastic and includes colors and patterns that gives it a vintage appearance. It is contemplated that the body 16 could have appearances other than a vintage appearance. For example, the body 16 could have a modern appearance.

A front 19 of the body 16 includes an opening 20, a window 21 and a plurality of knobs 24. The opening 20 is sized to receive a vessel 17 to collect candies 30 delivered by the candy distributor 38. A back 22 of the opening 20 is lit by a plurality of LEDs 23. It is contemplated that the opening 20 could be more or less large than shown in the Figures as long as it is sized to receive a cup or container to collect candies 30. It is also contemplated that the back 22 of the opening 20 could be lit by ways other than the plurality of LEDs 23. For example, the back 22 of the opening 20 could be lit by incandescent lights. It is also contemplated that sides of the opening 20 could be lit instead or in addition to the back 22 of the opening 20, It is also contemplated that the opening 20 could not be lit at all.

The window 21 allows to see the different candies 30 that the candy machine 10 may deliver. In the embodiment shown in the Figures, there are four silos 25 containing bulk candies 30, each silo 25 being able to contain a different type of small size bulk candies 30. It is contemplated that the candy machine 10 could include more or less than four silos 25. For example, the candy machine 10 could contain three or five silos 25. Vertically below the window 21 and vertically aligned with the four silos 25, are disposed the four knobs 24 associated each with one of the silos 25. Each of the knobs 24 is connected to a dispensing mechanism 40 which delivers a predetermined quantity of bulk candies 30 to the vessel 17 for a given rotation of the knobs 24. The dispensing mechanism 40 will be described below. It is contemplated that the knobs 24 could be connected to the dispensing mechanism 40 so that a rotation of any of the knobs 24 would be linked to a quantity of candies 30 dispensed as decided by the user without the dispensing mechanism 40 delivering a predetermined quantity of candies 30 at each rotation of the knobs 24. It is also contemplated that the knobs 24 could be replaced by buttons, or pull tabs for example.

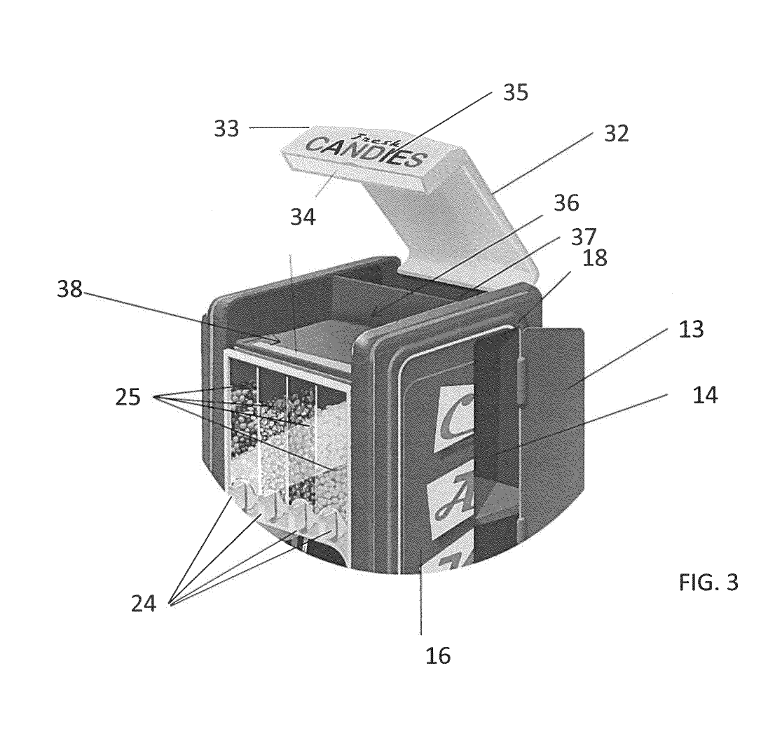

A side 18 of the body 16 can be opened up by a hinged panel 13 to access a storage compartment 14 (shown in FIG. 3). The storage compartment 14 allows to store additional candies 30 and cups 17. It is contemplated that the storage compartment 17 could be omitted. It is also contemplated that each side 18 of the body 16 could include a storage compartment 14. It is contemplated that the storage compartment 14 could be accessed via two or more hinged panels, or by removable panels that would be clipped instead of hinged to the side 18 of the body 16.

As best shown in FIG. 3, a top 32 of the body 16 flips up open to access an inside of the candy machine 10. The top 32 has a front portion 33 that when the top 32 is closed (as shown in FIG. 2), the front portion 33 is part of the front 19 of the body 16. The front portion 33 includes a plurality of LEDs 34 which lighten an inscription 35 on the front portion 33. When the top 32 is closed, the plurality of LEDs 34 also lighten the candies 30 in the silos 25 to enable the user to better see the different candies 30 in the silos 25. It is contemplated that the front portion 33 of the top 32 could be lit by ways other than the plurality of LEDs 34. For example, the front portion 33 of the top 32 could be lit by incandescent lights. It is also contemplated that the opening top 32 could not be lit at all or that only the candies 30 or only the inscription 35 could be lit. It is also contemplated that the lightening of the inscription 35 and of the candies 30 could be achieved independently from each other.

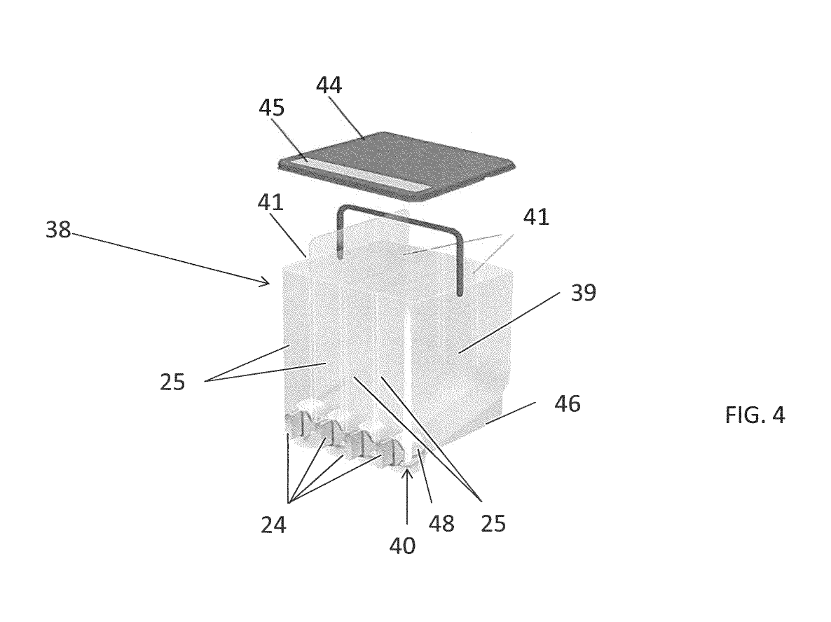

An inside 36 of the candy machine 10 includes a storage compartment 37 disposed behind a candy distributor 38. The storage compartment 37 allows to store additional candies 30 and cups 25. It is contemplated that the storage compartment 37 could be omitted. As best seen in FIG. 4, the candy distributor 38 includes a storage bin 39 having three removable dividers 41 creating the four silos 25. That way compartment if different sizes and compartment related to more than one knob 24 can be created. It is contemplated that the dividers 41 could be fixed to the storage bin 39. A bottom 46 of the storage bin 39 is inclined downwardly toward the dispensing mechanisms 40 to allow the candies 30 to move toward the dispensing mechanisms 40 by gravity. The storage bin 39 has an open top 42 which is covered by a removable cover 44. The cover 44 allows access to the candies 30 in the silos 25 and to preserve the freshness of the candies being stored. The cover 44 includes a transparent portion 45 which is aligned with the plurality of LEDs 34 of the front portion 33 when the top 32 is closed so as to lighten the candies 30 on their silos 25.

Each of the dispensing mechanisms 40 includes an associated valve 48 disposed inside the storage bin 39. Each valve 48 is operated by a corresponding knob 24, When the knob 24 is rotated, the valve 48 opens and delivers bulk candies 30 to the vessel 17. When the knob 24 is left vertical as shown in FIG. 4, the valve is closed and no candies 30 are delivered to the vessel 17. It is contemplated that the dispensing mechanism 40 could deliver a predetermined quantity of bulk candies 30 for each rotation of its associated knob 24.

The candy machine 10 is connected to the pedestal 14 by two latches (not shown) disposed on the bottom of the body 16. The latches are spring loaded. To disconnect the candy machine 10 to the pedestal 14, the user forces the latches against the spring load, The user uses a trap door (not shown) in the body 16 to access the latches when the candy machine 10 is connected to the pedestal 14. It is contemplated that the user could access the latches via an opening in the pedestal 14. The trap door is located within the opening 20. It is contemplated that the trap door could be located somewhere else. For example, the trap door could be located at a back or at the bottom of the body 16. It is also contemplated that access to the latches could be granted via ways other than the trap door. For example, a simple opening of a hinged door could be used. It is contemplated that the candy machine 10 could be connected to the pedestal 14 by additional means. For example, brackets could secure the back of the candy machine 10 to a back of the pedestal 14. It is contemplated that the candy machine 10 could be connected by more than two latches or by a different system. For example, the candy machine 10 could have a female bottom, and the pedestal 14 a male top connecting to the female bottom (or the opposite). The free standing machine would then be held by gravity with or without the help of additional connectors.

The pedestal 14 has a generally parallelipedic body 50 having a same cross-section as the one of the candy machine 10 so as to form a continuous free standing machine. It is contemplated that the pedestal 14 could be larger or smaller and/or have a cross-section different from the one of the candy machine 10. The pedestal 14 includes fours structural posts (not shown) disposed each at a corner of the parallelipedic body 50, The body 50 is made of plastic and is hollow. An inside of the body 50 can be filled with water or sand to weight the pedestal 14 down. The pedestal 14 also includes two locking caster wheels (not shown) disposed at a back of the pedestal 14, and two adjustable screw feet (not shown) disposed at a front of the pedestal 14. The wheels and feet facilitate the moving around of the candy machine 10 and pedestal 14, It is contemplated that the wheels and feet could be omitted. It is also contemplated that the tabletop base 12 could be filled with water or sand to weight the pedestal 14 down.

To convert the candy machine 10 from a free standing machine to a tabletop appliance, the user disconnects the candy machine 10 from the pedestal 14 by disconnecting the latches as described above. The user then connects the candy machine 10 to the tabletop base 12 by snapping. It is contemplated that the tabletop base 12 could be omitted and that the candy machine 10 could be used as is as a tabletop appliance once disconnected from the pedestal 14. It is also contemplated that the candy machine 10 could be connected to the tabletop base 12 by way other than snapping. For example, brackets could connect the candy machine 10 to the tabletop base 12. The tabletop base 12 is also connectable to a bottom of the pedestal 14. It is contemplated that the tabletop base 12 could be incompatible with the pedestal 14.

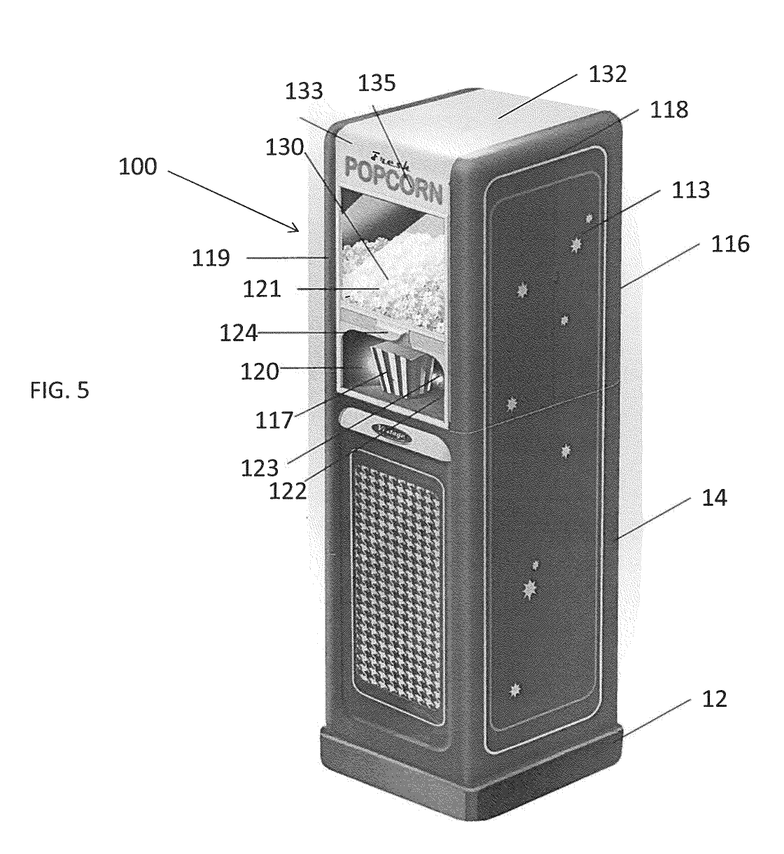

Turning now to FIGS. 5 to 10, a first embodiment of a popcorn making and distribution machine 100 will be described.

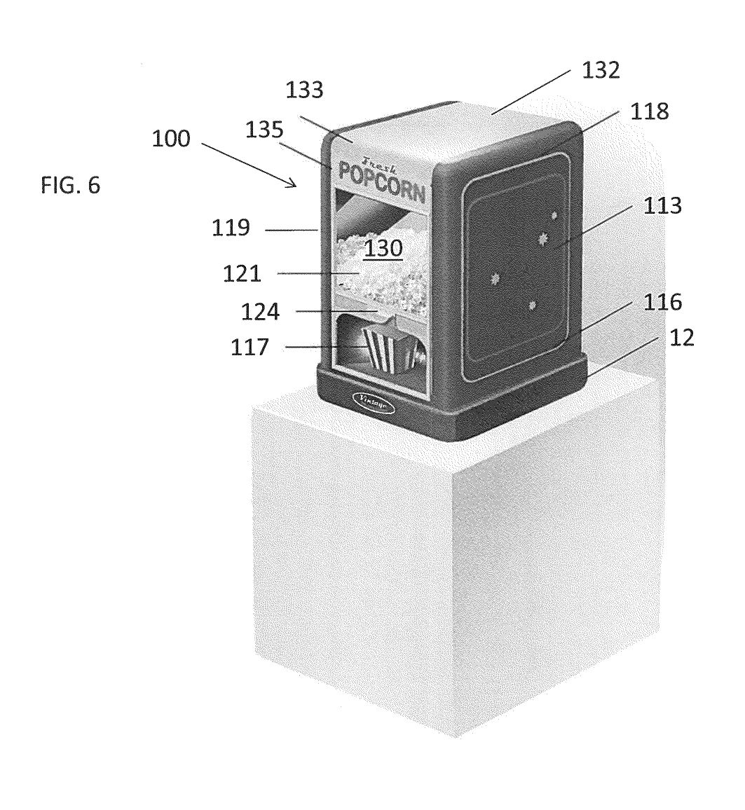

The popcorn machine 100 is a unit convertible between a free standing machine shown in FIG. 5 and a tabletop appliance shown in FIG. 6. To this end the popcorn machine 100 is connectable to a tabletop base such as the tabletop base 12 described above to become a tabletop appliance, and to a pedestal such as the pedestal 14 described above to become a free standing machine. The tabletop 12 and the pedestal 14 have been described above. It is contemplated however, that the popcorn machine 100 could be only a tabletop appliance or only a free standing machine without possibility of conversion between these two.

The popcorn machine 100 includes a generally parallelipedic body 116. A bottom (not shown) of the body 116 is connectable to the tabletop base 12 and to the pedestal 14. The body 116 is made of plastic and includes colors and patterns that gives it, in this example, a vintage appearance. It is contemplated that the body 116 could have appearances other than a vintage appearance. For example, the body 116 could have a modern appearance.

A front 119 of the body 116 includes a window 121 through which the popcorn 130 can be seen and an opening 120 vertically below the window 121 sized to receive a cup 117 to collect the popcorn 130.

A back 122 of the opening 120 is lit by a plurality of LEDs 123. R is contemplated that the opening 120 could be more or less large than shown in the Figures as long as it is sized to receive a cup or container to collect popcorn 130. R is also contemplated that the back 122 of the opening 120 could be lit by ways other than the plurality of LEDs 123. For example, the back 122 of the opening 120 could be lit by incandescent lights. It is also contemplated that sides of the opening 120 could be lit instead or in addition to the back 122 of the opening 120, It is also contemplated that the opening 120 could not be lit at all,

A side 118 of the body 116 can be opened up by a hinged panel 113 to access a storage compartment 114 (shown in FIG. 8). The storage compartment 114 allows to store additional corn kernels and cups. It is contemplated that the storage compartment 114 could be omitted. It is also contemplated that each side 118 of the body 116 could include one or more storage compartment 114. It is contemplated that the storage compartment 114 could be accessed via two or more hinged panels, or by removable panels that would be clipped instead of hinged to the side 118 of the body 116,

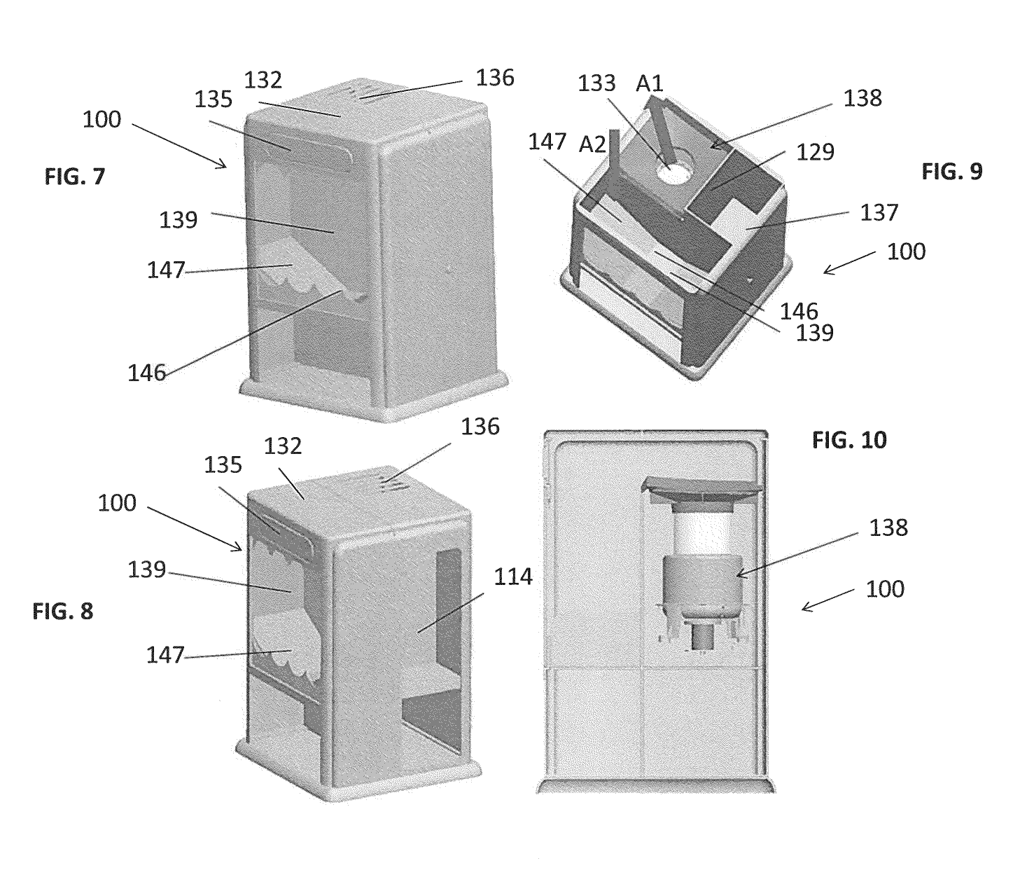

Similarly to the candy machine 10, a top 132 of the body 116 of the popcorn machine 100 flips up open to access an inside of the popcorn machine 100. The top 132 has a front portion 133 that when the top 132 is closed is part of the front 119 of the body 116. The front portion 133 includes a plurality of LEDs (not shown) which lighten an inscription 135 (In this example “Fresh Popcorn”) on the front portion 133. When the top 132 is closed, the plurality of LEDs 134 also lighten the popcorn 130. It is contemplated that the front portion 133 of the top 132 could be it by ways other than the plurality of LEDs 134. For example, the front portion 133 of the top 132 could be lit by incandescent lights. It is also contemplated that the opening top 132 could not be lit at all or that only the popcorn 130 or only the inscription 135 could be lit. It is also contemplated that the lightening of the inscription 135 and of the popcorn 130 could be achieved independently from each other. The top 132 also include vents 136 (shown in FIG. 7) in relation with a hot air popper 138.

As best seen in FIG. 9, an inside of the popcorn machine 100 includes the hot air popper 138 disposed vertically below the vents 136, a storage compartment 137 disposed adjacent to the hot air popper 138, and a popcorn receptacle 139 disposed forward of the hot air popper 138 and storage compartment 137. The vents 136 form a ventilation system which vent the hot air from the hot air popper 138 and prevents internal components and parts to overheat. The storage compartment 137 allows to store additional corn kernels and/or cups. It is contemplated that the storage compartment 137 could be omitted. The hot air popper 138 is a conventional hot air popcorn maker where hot air is forced corn kernels which pop under the effect of the heat and flow upwardly (see arrow A1) through an opening 133 to fall into the popcorn receptacle 139 (see arrow A2). A wall 129 separating the storage compartment 137 from the hot air popper 138 is high enough so that the popcorns 130 won't fly into the storage compartment 137 by error. The popcorn 130 may impact the top 132 when flying upwardly and bounce on an undersurface of the top 132 to and in the popcorn receptacle 139. The opening 133 is also used as an inlet to feed the corn kernels into the hot air popper 138. Although the hot air popper 138 is shown in this embodiment to be located at a back of the popcorn maker 100 and the popcorn receptacle 139 at a front, it is contemplated that the hot air popper 138 could be disposed elsewhere relative to the popcorn receptacle 139, as long as they are close enough to enable the popcorn 130 to fall naturally from the hot air popper 138 into the popcorn receptacle 139. For example, the hot air popper 138 could be disposed centrally in the popcorn receptacle 139.

A bottom 146 of the popcorn receptacle 139 has one or more inclined walls 147 so as to form a funnel and direct popcorns 130 toward a dispensing mechanism by gravity. The bottom 146 is closed by a slideable tray 124, which acts as a valve and as the dispensing mechanism. When the slidable tray 124 is inserted, the popcorn 130 is retained in the popcorn receptacle 139, and when the slidable tray 124 is partially or totally removed, the popcorn 130 evacuated from the popcorn receptacle 139 through the opening that was once covered by the slidable tray 124 toward the cup 117. As such, the popcorn machine 100 provides an integrated popcorn making and delivery system thanks to the hot air popper 138 and the conveniently located popcorn receptacle 139 and valve 124 enable delivery of the popcorn without human manipulation of the popcorn. The valve 124 may have various shapes. For example, the valve 124 may be made of hinged flaps, or be spring loaded. The valve 124 may be operated manually or mechanically.

The popcorn machine 100 is connectable to the pedestal 14 in the same ways as described for the candy machine 10 for use as a free standing machine or alternatively as a table top appliance. To convert the popcorn machine 100 from a free standing machine to a tabletop appliance, the user disconnects the popcorn machine 100 from the pedestal 14 and connects it to the tabletop base 12 in the manner described above for the candy machine 10.

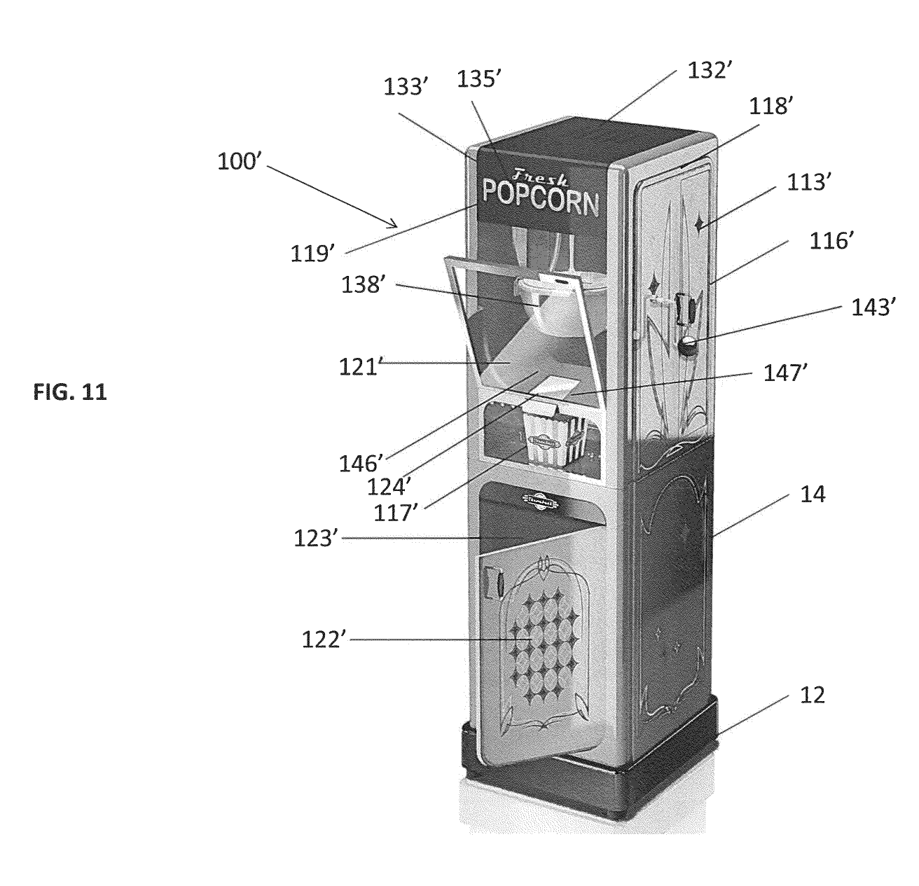

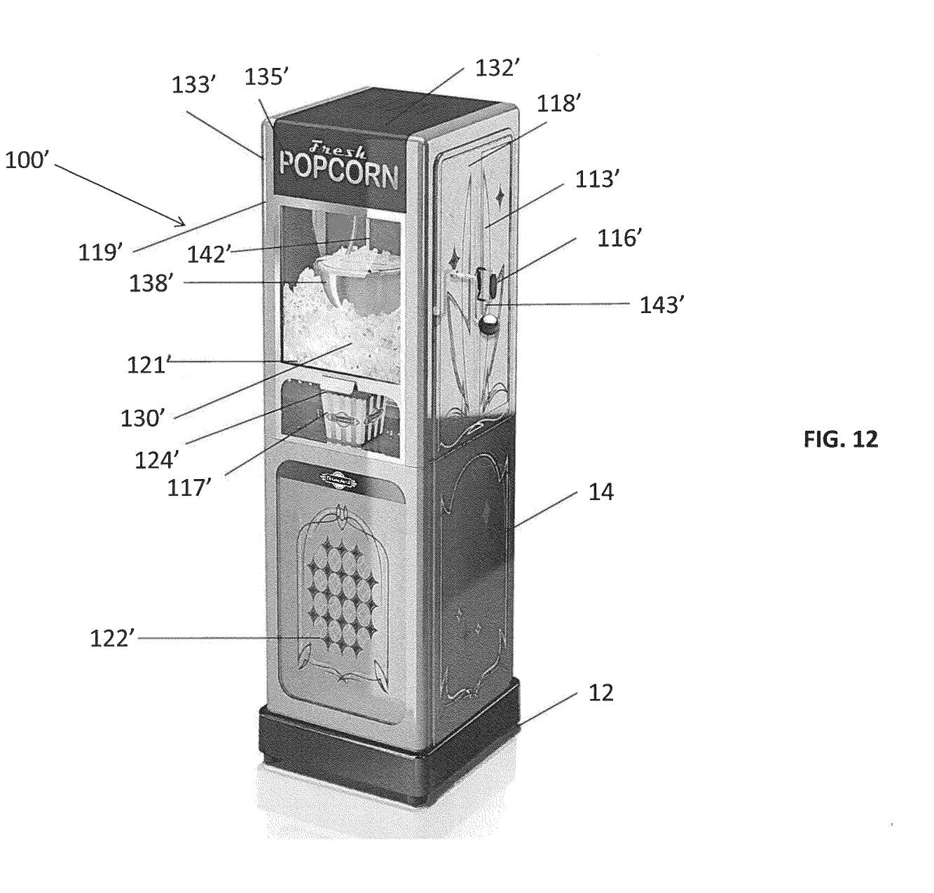

Turning now to FIGS. 11 and 12, a second embodiment of a popcorn making and distribution machine 100′ will be described. The popcorn machine 100′ has common elements to the popcorn machine 100. These elements will have same reference numerals but with a prime' and will not be described in details herein again.

The popcorn machine 100′ is a unit convertible between a free standing machine shown in FIGS. 11 and 12 and a tabletop appliance (not shown) similarly to the popcorn machine 100. To this end the popcorn machine 100′ is connectable to a tabletop base such as the tabletop base 12 described above to become a tabletop appliance, and to a pedestal such as the pedestal 14 described above to become a free standing machine. The tabletop 12 and the pedestal 14 have been described above. It is contemplated however, that the popcorn machine 100′ could be only a tabletop appliance or only a free standing machine without possibility of conversion between these two.

The popcorn machine 100′ includes a generally parallelipedic body 116′. The body 116′ is made of plastic and includes colors and patterns that gives it, in one embodiment, a vintage appearance. A front 119′ of the body 116′ includes a window 121′ through which popcorn 130′ (shown in FIG. 12) can be seen, and an opening 120′ vertically below the window 121′ sized to receive a cup 117′ to collect the popcorn 130′. A front panel 122′ may be operable to access a storage compartment 123′. It is contemplated that the storage compartment 123′ could be omitted and the front panel 122′ may be fixed. A side 118′ of the body 116′ may be opened up by a hinged panel 113′ to access yet another storage compartment (not shown).

Similarly to the popcorn machine 100, a top 132′ of the body 116′ of the popcorn machine 100′ flips up open to access an inside of the popcorn machine 100. The top 132′ has a front portion 133′ that when the top 132′ is closed is part of the front 119′ of the body 116′. The front portion 133′ includes a plurality of LEDs (not shown) which lighten an inscription 135′ (in this example “Fresh Popcorn”) on the front portion 133′, When the top 132′ is closed, the plurality of LEDs also lighten the popcorn 130′.

The popcorn machine 100′ differs from the popcorn machine 100 mostly by its inside. Instead of a hot air popper, the popcorn machine 100′ includes a kettle popper 138′ disposed centrally in a popcorn receptacle 139′, The popcorn receptacle 139′ is accessible by the hinged window 121′.

The kettle popper 138′ is a conventional popper including a bin 140′ with a heater disposed at a base of the bin 140′. The kettle popper 138′ further includes a rotating arm (not shown) connected to a spindle 142′ operated by a motor (not shown). The rotating arm stir hot oil and corn kernel disposed in the bin 140′. A crank arm 143′ may be used to rotate the kettle popper 138′ when the corn is popped in order to ensure that no remaining corn is left in the bin 140′.

The kettle popper 138′ is generally circular and is disposed centrally in the popcorn receptacle 139′ to allow the collection of the popcorn 130′ by the popcorn receptacle 139′ as it is being popped by the kettle popper 138′. When the corn kernel are popped, they are expelled upwardly and fall back downwardly due to gravity into the popcorn receptacle 139′. It is contemplated that the kettle popper 138′ could be disposed elsewhere relative to the popcorn receptacle 139′, as long as they are close enough to enable the popcorn 130′ to fall naturally from the hot air popper 138′ into the popcorn receptacle 139′,

Similarly to the popcorn receptacle 139, a bottom 146′ of the popcorn receptacle 139′ has one or more inclined walls 147′ so as to form a funnel and direct popcorns 130 toward a dispensing mechanism by gravity. The bottom 146′ is closed by a slideable tray 124′, which acts as a valve and as the dispensing mechanism. Other types of valves are contemplated. When the slidable tray 124′ is inserted, the popcorn 130′ is retained in the popcorn receptacle 139′, and when the slidable tray 124′ is partially or totally removed, the popcorn 130′ evacuated from the popcorn receptacle 139′ to the cup 117′ through an opening that was once covered by the slidable tray 124′. As such, the popcorn machine 100′, similarly to the popcorn machine 100 provides an integrated popcorn making and delivery system thanks to the kettle popper 138′ and the conveniently located popcorn receptacle 139′ and valve 124′ enable delivery of the popcorn without human manipulation of the popcorn. The valve 124′ may have various shapes. For example, the valve 124′ may be made of hinged flaps, or be spring loaded. The valve 124′ may be manually or mechanically operated.

The popcorn machine 100′ is connectable to the pedestal 14 in the same ways as described for the popcorn machine 100. To convert the popcorn machine 100′ from a free standing machine to a tabletop appliance, the user disconnects the popcorn machine 100′ from the pedestal 14 and connects it to the tabletop base 12 in the manner described above for the candy machine 10,

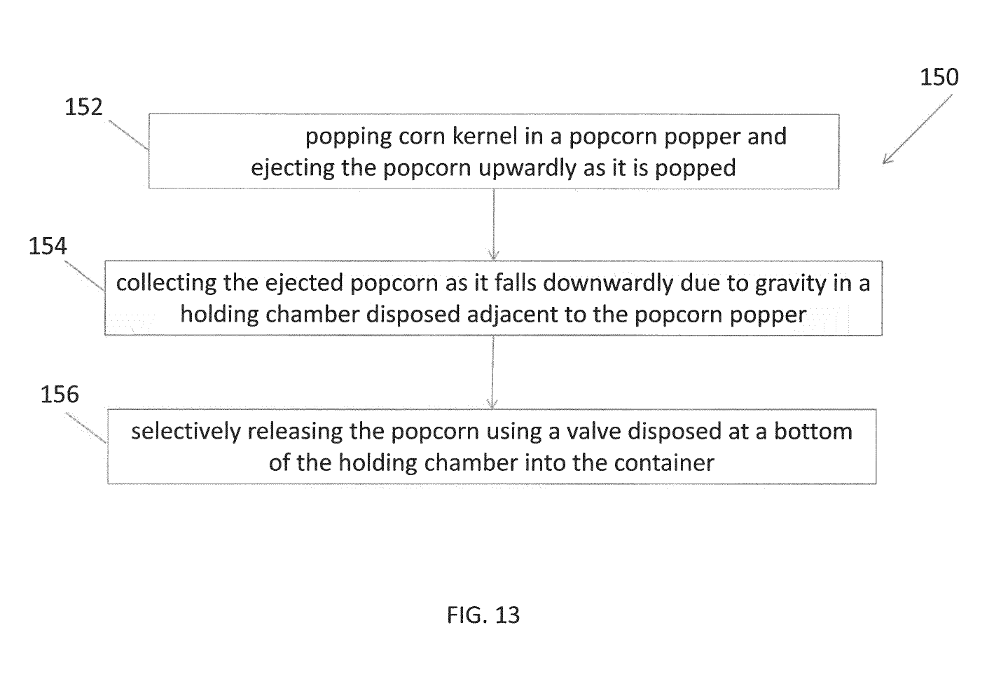

Turning now to FIG. 13, a method 150 of making and delivering popcorn using either of popcorn machines 100 and 100′ will be described.

The method 150 starts at step 152 where popping corn kernel is popped in the popcorn popper 138 or 138′ and is ejected upwardly (arrow Al in FIG. 9) as it is popped.

At step 154, the ejected popcorn 130, 130′ is collected by the popcorn receptacle 139 or 139′ as it falls downwardly due to gravity (arrow A2 in FIG, 9), The popcorn 130, 130′ may be deflected by wall 129 or top 132, 132′ so as to be directed into the popcorn receptacle 139, 139′. In the case of the popcorn machine 100′, there may be no deflection onto walls since the kettle popper 138′ is centrally located in the popcorn receptacle 139′. The popcorn 130, 130′ may then accumulate in the popcorn receptacle 139 or 139′. Because the popcorn receptacle 139 or 139′ has an inclined wall 147 or 147′, the popcorn 130, 130′ gravitates toward the valve 124 or 124′ disposed at the bottom 146 or 146′ of the popcorn receptacle 139 or 139′.

At step 156, the popcorn 130, 130′ is electively released using the valve 124 or 124′ into the cup 117 or 117′.

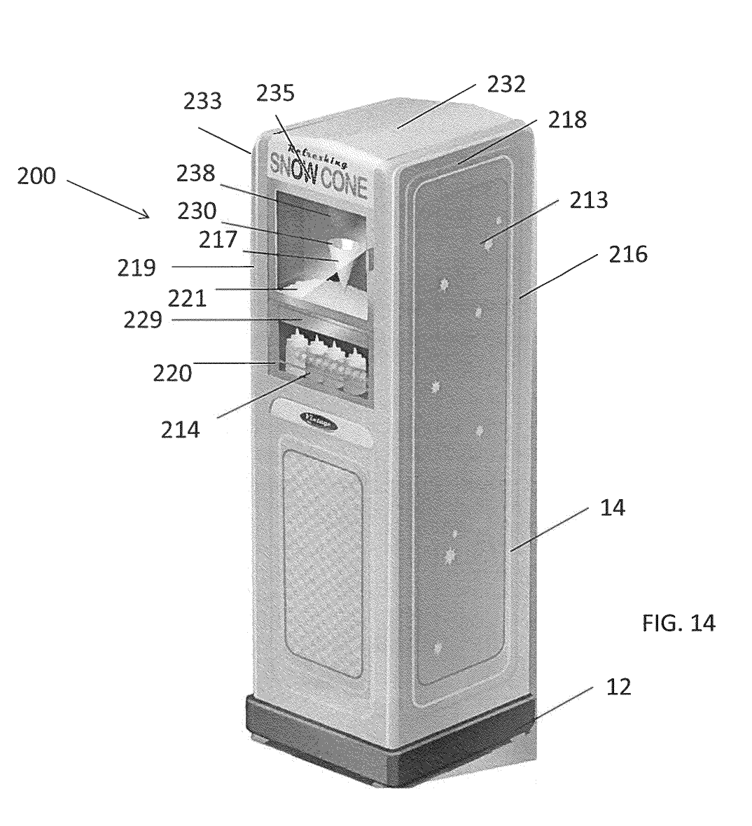

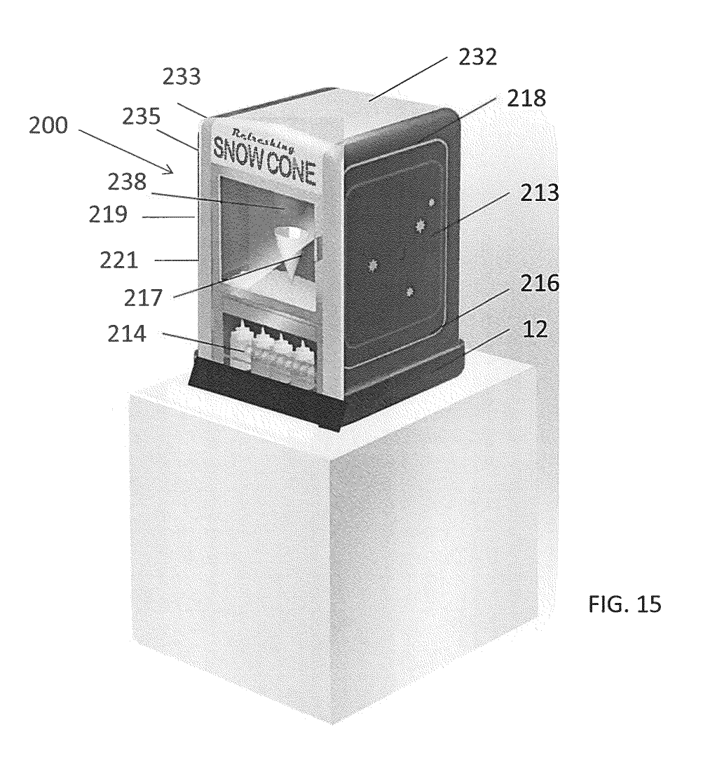

Turning now to FIGS. 14 and 15, a snow cone machine 200 will be described.

The snow cone machine 200 is a unit convertible between a free standing machine shown in FIG. 14 and a tabletop appliance shown in FIG. 15. To this end the snow cone machine 200 is connectable to a tabletop base such as the tabletop base 12 to become a tabletop appliance, and to a pedestal such as the pedestal 14 to become a free standing machine. The tabletop 12 and the pedestal 14 have been described above. It is contemplated however, that the snow cone machine 200 could be only a tabletop appliance or only a free standing machine without possibility of conversion between these two.

The snow cone machine 200 includes a generally parallelipedic body 216. A bottom (not shown) of the body 216 is connectable to the tabletop base 12 and to the pedestal 14. The body 216 is made of plastic and includes colors and patterns that gives it a vintage appearance. It is contemplated that the body 216 could have appearances other than a vintage appearance. For example, the body 216 could have a modern appearance.

A front 219 of the body 216 includes an opening 220 and a window 221. The opening 20 is sized to receive a plurality of flavouring containers 217 which are poured over a snow cone 230 once it is made. A back (hidden by the flavouring containers 217 in the figures) of the opening 220 is lit by a plurality of LEDs (also hidden by the flavouring containers 217 in the figures). It is contemplated that the opening 220 could be more or less large than shown in the Figures. It is contemplated that the opening 220 could be omitted. It is also contemplated that the opening 220 could be replaced by an outwardly extending tray to hold the flavouring containers 217. It is also contemplated that the back of the opening 220 could be lit by ways other than the plurality of LEDs, For example, the back of the opening 220 could be lit by incandescent lights. It is also contemplated that sides of the opening 220 could be lit instead or in addition to the back of the opening 220. It is also contemplated that the opening 220 could not be lit at all. The window 221 allows to see the snow cone 230 being made. The window 221 is hingedly connected to the body 216. During making of the snow cone 230, the window 221 is closed. Once the snow cone 230 is made, the window 221 is opened up to extract the snow cone 230 from the snow cone machine 200 in order to serve it to the user. The window 221 does not have to be closed to allow the motor to run. The user may run the snow cone machine 200 by depressing the button so as to fill up a container of shaved ice for a larger vessel or for a beverage (for example margarita),

Similarly to the candy machine 10 and the popcorn machine 100, a side 218 of the body 216 of the snow cone machine 200 can be opened up by a hinged panel 213 to access a storage compartment (not shown). The storage compartment allows to store additional ice, and/or flavouring containers, and/or cups. It is contemplated that the storage compartment could be omitted. It is also contemplated that each side 218 of the body 216 could include a storage compartment. It is contemplated that the storage compartment could be accessed via two or more hinged panels, or by removable panels that would be cupped instead of hinged to the side 218 of the body 216.

Also similarly to the candy machine 10 and the popcorn machine 100, a top 232 of the body 216 flips up open to access an inside of the snow cone machine 200, The top 232 has a front portion 233 that when the top 232 is closed, the front portion 233 is part of the front 219 of the body 216. The front portion 233 includes a plurality of LEDs 234 which lighten an inscription 235 on the front portion 233. When the top 232 is closed, the plurality of LEDs 234 also lighten the snow cone 230 during its making. It is contemplated that the front portion 233 of the top 232 could be lit by ways other than the plurality of LEDs 34. For example, the front portion 233 of the top 232 could be lit by incandescent lights. It is also contemplated that the opening top 232 could not be lit at all or that only the snow cone 230 or only the inscription 235 could be lit. It is also contemplated that the lightening of the inscription 235 and of the snow cone 230 could be achieved independently from each other.

An inside of the snow cone machine 210 includes a funnel (not shown) which holds larger pieces of ice, a chute 238 to channel the ice downwards, and a blade (not shown) disposed at the base of the funnel. The blade is entrained in rotation by a motor (not shown). Ice impacts the blade which transforms it into shaved ice. The shaved ice falls into the chute 238, and then into a vessel 217 of the snow cone 230 held by two prongs (not shown). The two prongs are adjustable and removable, The amount of ice fed to the chute 238 is determined by how long the user activates the motor. The motor is actuated by a button (not shown) that activates the motor only when pressed. It is contemplated however, that upon a single actuation, the motor could run for a predetermined amount of time corresponding to the time needed to shave a single vessel 217 of ice, Should excess of water or ice flow over the snow cone 230, it would be recuperated by a tray 229 disposed vertically below the snow cone 230. The tray 229 is removable from the body 216 in order to trash the excess water and ice.

The snow cone machine 200 is connectable to the pedestal 14 in the same ways as described for the candy machine 10,

To convert the snow cone machine 200 from a free standing machine to a tabletop appliance, the user disconnects the snow cone machine 200 from the pedestal 14 and connects it to the tabletop base 12 in the manner described above for the candy machine 10.

Referring to HG. 13, a cotton candy machine 300 will be described.

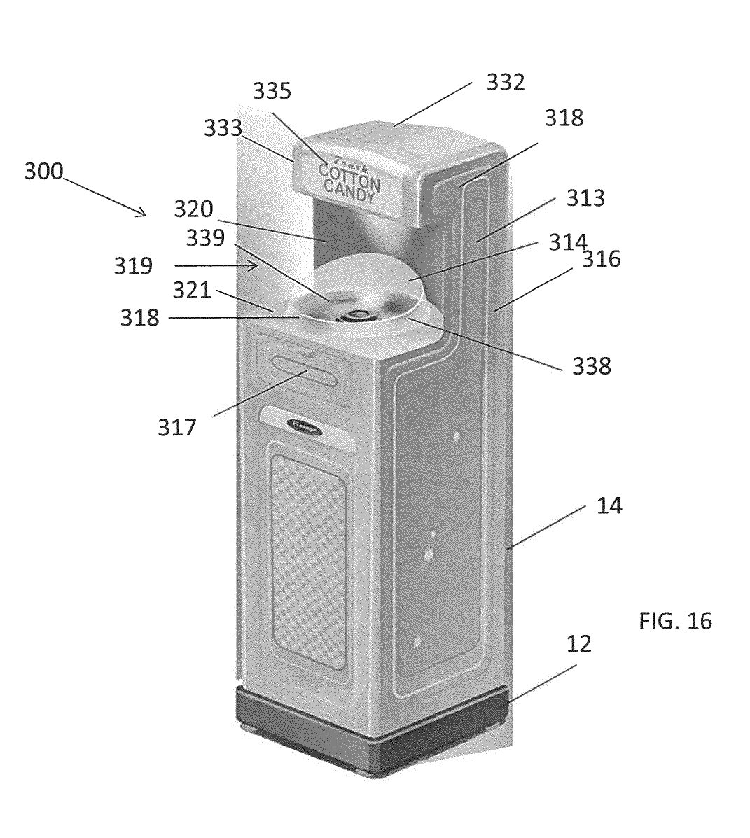

The cotton candy machine 300 is a unit convertible between a free standing machine shown in FIG. 16 and a tabletop appliance, similarly to what has been described above for the candy machine 10, popcorn machine 100, and snow cone machine 200. To this end the cotton candy machine 300 is connectable to a tabletop base such as the tabletop 12 to become a tabletop appliance, and to a pedestal such as the pedestal 14 to become a free standing machine. The tabletop base 12 and the pedestal 14 have been described above. It is contemplated however, that the cotton candy machine 300 could be only a tabletop appliance or only a free standing machine without possibility of conversion between these two.

The cotton candy machine 300 includes a generally parallelipedic body 316. The body 316 is made of plastic and includes colors and patterns that gives it a vintage appearance. It is contemplated that the body 316 could have appearances other than a vintage appearance. For example, the body 316 could have a modern appearance.

A front 319 of the body 316 includes a recess 320 and a storage compartment 317. The recess 320 accommodates a cotton candy machine 318, which will be described below, The storage compartment 317 allows to store for example sugar. It is contemplated that the storage compartment 317 could be omitted.

A side 318 of the body 316 can be opened up by a hinged panel 313 to access a storage compartment (not shown). The storage compartment allows to store additional granulated sugar and recipients for the cotton candy. It is contemplated that the storage compartment could be omitted. It is also contemplated that each side 318 of the body 316 could include a storage compartment. It is contemplated that the storage compartment could be accessed via two or more hinged panels, or by removable panels that would be clipped instead of hinged to the side 318 of the body 316.

A top 332 of the body 316 flips up open to access yet another storage compartment (not shown) of the cotton candy machine 300, The top 332 has a front portion 333 that when the top 332 is closed, the front portion 333 forms a front 319 of the body 316. The front portion 333 includes a plurality of LEDs which lighten an inscription 335 on the front portion 333 and the front 319 of the cotton candy machine 300. It is contemplated that the front portion 333 of the top 332 could be lit by ways other than the plurality of LEDs. For example, the front portion 333 of the top 332 could be lit by incandescent lights. It is also contemplated that the opening top 332 could not be lit at all. It is contemplated that the top 332 could be fixedly connected to the body 316 and that there would be no storage compartment below the top 332.

The cotton candy maker 300 includes a stainless steel basin 338 fixed to a horizontal platform 321 formed in the recess. The basin 338 is heated by heating elements (not shown) disposed below the body 316. A metal disk 339 is disposed within the basin 338. The metal disk 339 is operatively connected to a motor (not shown) disposed in the body 316 vertically below the basin 338. The motor drives the metal disk 339 in rotation. The metal disk 339 includes a plurality of small holes disposed on a rim of the metal disk 339. When granulated sugar is spinned within the basin 338 and the metal disk 339, the liquefied sugar passes through the holes which transforms then into threads of cotton candy. A transparent edging 314 is disposed partially around the basin 338 to avoid the cotton candy to fly around.

The cotton candy machine 300 is connectable to the pedestal 14 in the same ways as described for the candy machine 10.

To convert the cotton candy machine 300 from a free standing machine to a tabletop appliance, the user disconnects the cotton candy machine 300 from the pedestal 14 and connects it to the tabletop base 12 in the manner described above for the candy machine 10.

Modifications and improvements to the above-described embodiments of the present may become apparent to those skilled in the art. The foregoing description is intended to be exemplary rather than limiting. The scope of the present is therefore intended to be limited solely by the scope of the appended claims.

We claim:

1. A machine for popping corn out of corn kernel and for delivering the popcorn to a container, the machine comprising:
a body including:
a popcorn popper; and
a popcorn receptacle disposed adjacent to the popcorn popper, when the popcorn popper is in operation, popcorn expelled by the popcorn popper falling into the popcorn receptacle, the popcorn receptacle having at least one inclined wall; and
a valve disposed in the popcorn receptacle at a bottom end of the at least one inclined wall, the valve selectively releasing the popcorn from the popcorn receptacle to the container.

2. The popcorn making and delivering machine of claim 1, wherein the body includes an opening receiving the container, the opening being disposed vertically below the valve, popcorn released by the valve falling into the container.

3. The popcorn making and delivering machine of claim 1, wherein the popcorn popper is disposed at a back of the body, and the popcorn receptacle is disposed at a front of the body.

4. The popcorn making and delivering machine of claim 1, wherein the popcorn popper is disposed centrally in the popcorn receptacle.

5. The popcorn making and delivering machine of claim 1, wherein the body further comprises a corn kernel storage compartment disposed, inside the body, adjacent of the popcorn receptacle and of the popcorn popper.

6. The popcorn making and delivering machine of claim 1, wherein the body further includes a top selectively movable between an open and a close position, the open position allowing access to the popcorn receptacle and the popcorn popper.

7. The popcorn making and delivering machine of claim 6, wherein the top is hinged between an open position and a closed position, the top having a front portion, the front portion including a light, when in the closed position the light illuminating the popcorn receptacle.

8. The popcorn making and delivering machine of claim 7, wherein when in the closed position the light illuminating an inscription on the front portion.

9. The popcorn making and delivering machine of claim 1, wherein the valve is a slidable tray.

10. The popcorn making and delivering machine of claim 1, wherein the body is removably connected to a vertically elongated pedestal allowing the popcorn making and delivering machine to convert from a table top appliance to free standing machine.

11. The popcorn making and delivering machine of claim 1, wherein the popcorn popper is one of a kettle popper and a hot air popper.

12. A method of making and delivering popcorn in a popcorn machine to a container, the method comprising:
popping corn kernel in a popcorn popper thereby forcing the popcorn to be ejected upwardly as it is popped;
collecting the ejected popcorn as it falls downwardly due to gravity in a popcorn receptacle disposed adjacent to the popcorn popper; and
selectively releasing the popcorn using a valve disposed at a bottom of the popcorn receptacle into the container.

13. The method of claim 12, further comprising deflecting the popcorn downwardly as it hits a top of the popcorn machine toward the popcorn receptacle after popping the corn kernel and before collecting the ejected popcorn in the popcorn receptacle.

14. The method of claim 12, further comprising directing the popcorn in the popcorn receptacle toward the valve against at least one inclined wall of the popcorn receptacle before selectively releasing the popcorn using the valve and after collecting the ejected popcorn n the popcorn receptacle.
